(19) United States
(12) Patent Application Publication
(10) Pub. No.: US 2004/0201966 A1
(43) Pub. Date: Oct. 14, 2004

(54) Heat conducting body with a thermo-chromic dye coated thereon

(76) Inventor: Jeffrey Kao, Chung-Ho City (TW)

Correspondence Address: TROP PRUNER & HU, PC, 8554 KATY FREEWAY, SUITE 100, HOUSTON, TX, 77024, US

(21) Appl. No.: 10/797,229

(22) Filed: Mar. 10, 2004

(30) Foreign Application Priority Data
Apr. 10, 2003 (TW) 092108261

(51) Int. Cl. G03C 1/492

(52) U.S. Cl. 361/710

(57) ABSTRACT

A heat sink includes a heat dissipating body having a visible outer surface, and a thermo-chromic dye coated on the visible outer surface of the heat dissipating body. The thermo-chromic dye is capable of changing color in response to temperature change of the heat dissipating body. In addition, a power supply includes a housing having a visible outer surface, and a thermo-chromic dye coated on the visible outer surface of the housing. The thermo-chromic dye is capable of changing color in response to temperature change of the housing.

### CROSS-REFERENCE TO RELATED APPLICATION

This application claims priority of Taiwan Patent Application No. 092108261, filed on Apr. 10, 2003.

### BACKGROUND OF THE INVENTION

1. Field of the Invention

This invention relates to a heat conducting body, more particularly to a heat conducting body, such as a heat sink or a housing of a power supply, with a thermo-chromic dye coated thereon.

2. Description of the Related Art

For electronic equipments, such as a computer, in which a motherboard is included as a main component, the motherboard is provided with a plurality of electronic components, such as integrated circuit chips including a central processing unit (CPU), south and north bridge chips, a graphics processing chip and so on. As the computer is required to speed up arithmetic processing, the heat generated from the electronic components included in the computer increases. Particularly, the heat generated by the integrated circuit chips has increased to an extent that injuries can result upon accidental contact.

In order to solve the abovementioned problem in the art, a heat sink made from high thermo-conductive material, such as aluminum or copper, have been widely used in the motherboard of the computer. The heat sink conducts heat exchange with air or other media so as to dissipate the heat generated by the electronic components and thereby promote cooling of the electronic components to a normal operating temperature. Consequently, the electronic components can be prevented from burning out or shutting down due to overheating.

When an operator conducts a testing operation of the computer for a long period of time, the temperature of the heat sink or the housing of the power supply may rise to a dangerous extent that the operator may get burned when unintentionally touching the heat sink or the housing of the power supply.

Therefore, for safety concern, there is a need in the art to provide a high-temperature warning design on the heat sink or the housing of the power supply.

### SUMMARY OF THE INVENTION

According one aspect of the present invention, a heat sink is adapted to be connected to an electronic device for dissipating heat generated therefrom, and includes a heat dissipating body having a visible outer surface and a thermo-chromic dye coated on the visible outer surface of the heat dissipating body. The thermo-chromic dye is capable of changing color in response to temperature change of the heat dissipating body.

According to another aspect of the present invention, a power supply includes a housing having a visible outer surface and a thermo-chromic dye coated on the visible outer surface of the housing. The thermo-chromic dye is capable of changing color in response to temperature change of the housing.

### BRIEF DESCRIPTION OF THE DRAWINGS

Other features and advantages of the present invention will become apparent in the following detailed description of the preferred embodiments of the invention, with reference to the accompanying drawings. In the drawings:

FIG. 1 is a perspective view of the preferred embodiment of a heat sink according to this invention, which includes a thermo-chromic dye coated thereon; and

FIG. 2 is a perspective view of the preferred embodiment of a power supply according to this invention, which includes a housing with a thermo-chromic dye coated thereon.

### DETAILED DESCRIPTION OF THE PREFERRED EMBODIMENTS

This invention relates to a heat conducting body, such as a heat sink or a housing of a power supply, with a thermo-chromic dye coated thereon.

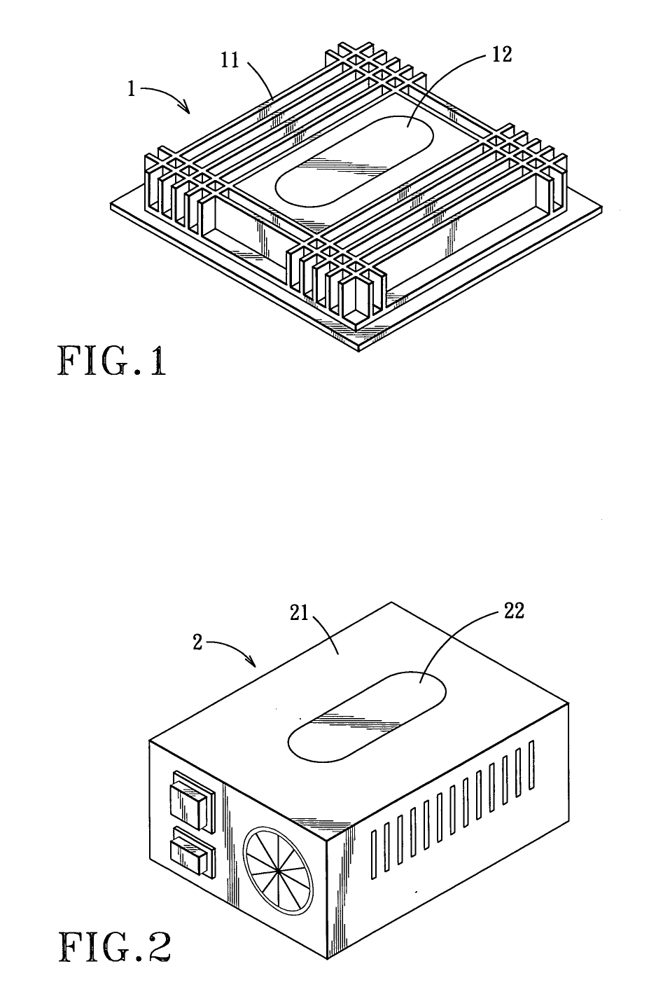

Referring to FIG. 1, the preferred embodiment of a heat sink 1 according to this invention, which is adapted to be connected to an electronic device (not shown) in a known manner for dissipating heat generated therefrom, includes a heat dissipating body 11 having a visible outer surface, and a thermo-chromic dye 12 coated on the visible outer surface of the heat dissipating body 11. For example, the heat sink 1 according to this invention is adapted to be connected to an integrated circuit chip, such as a central processing unit (CPU) or a graphics processing unit, so as to transfer heat and conduct heat exchange with air for dissipating the heat generated by the integrated circuit chip.

The thermo-chromic dye 12 is capable of changing color in response to temperature change of the heat dissipating body 11 of the heat sink 1. In this embodiment, the thermo-chromic dye 12 coated on the outer surface of the heat dissipating body 11 of the heat sink 1 changes color from transparent to red, gradually and reversibly, when temperature of the heat dissipating body 11 of the heat sink 1 changes from 40° C. to 80° C.

In detail, the thermo-chromic dye 12 appears transparent when the temperature of the heat dissipating body 11 of the heat sink 1 is below 40° C. The thermo-chromic dye 12 gradually changes color from transparent to pink when the temperature of the heat dissipating body 11 of the heat sink 1 rises between above 40° C. and below 80° C. The thermo-chromic dye 12 gradually changes color from pink to red when the temperature of the heat dissipating body 11 of the heat sink 1 rises above 80° C. Therefore, during a testing operation, the operator can appreciate visibly the actual temperature of the heat sink 1 and can be warned so as to avoid getting burned.

In addition, since the thermo-chromic dye 12 is more viscous than other conventional dyes, it is not suitable to be coated on the heat dissipating body 11 of the heat sink 1 by wet-printing. Preferably, the thermo-chromic dye 12 is coated on the heat dissipating body 11 of the heat sink 1 by spraying. The drying time for the thermo-chromic dye 12 sprayed on the heat dissipating body 11 of the heat sink 1 is longer than that for other conventional dyes.

The detailed description regarding the composition and suitable species of the thermo-chromic dye 12 are omitted herein since these are not the technical features of this invention and can be readily appreciated by those skilled in the art.

In addition, in using the thermo-chromic dye 12, the temperature distribution on the heat sink 1, which is helpful in product design, can be determined by gathering the information relevant to the color changing rate and color distribution of the thermo-chromic dye 12 on the heat sink 1.

Additionally, the thermo-chromic dye 12 coated on the heat dissipating body 11 of the heat sink 1 can be printed with a pattern, such as a logo or a trademark, so as to increase the aesthetic appeal of the heat sink 1 during the color change of the thermo-chromic dye 12.

Referring to FIG. 2, another preferred embodiment according to this invention is shown to be embodied in a power supply 2 that includes a housing 21 having a visible outer surface, and a thermo-chromic dye 22 coated on the visible outer surface of the housing 21. Similar to the preferred embodiment illustrated in FIG. 1, the thermo-chromic dye 22 is capable of changing color, from transparent to red, gradually and reversibly, in response to temperature change of the housing 21 when temperature of the housing 21 of the power supply 2 changes from 50° C. to 70° C.

By virtue of the thermo-chromic dye 12, 22, the heat sink 1 or the power supply 2 of this invention is capable of providing a warning sign to the operator, thereby eliminating the aforesaid drawbacks as encountered in the prior art.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A heat sink adapted to be connected to an electronic device for dissipating heat generated therefrom, said heat sink comprising a heat dissipating body having a visible outer surface and a thermo-chromic dye coated on said visible outer surface of said heat dissipating body, said thermo-chromic dye being capable of changing color in response to temperature change of said heat dissipating body.

2. The heat sink of claim 1, wherein said thermo-chromic dye changes color from transparent to red when temperature of said heat dissipating body changes from 40° C. to 80° C.

3. A power supply, comprising a housing having a visible outer surface and a thermo-chromic dye coated on said visible outer surface of said housing, said thermo-chromic dye being capable of changing color in response to temperature change of said housing.

4. The power supply of claim 3, wherein said thermo-chromic dye changes color from transparent to red when temperature of said housing changes from 50° C. to 70° C.
